(19) United States
(12) Patent Application Publication
(10) Pub. No.: US 2002/0082978 A1
(43) Pub. Date: Jun. 27, 2002

(54) System and method for soliciting bids

(76) Inventors: Ahmed Ghouri, San Diego, CA (US); David Chen, Cypress, CA (US); Erik Woodward, San Diego, CA (US)

Correspondence Address: CUMMINGS & LOCKWOOD, Four Stamford Plaza, P.O. Box 120, Stamford, CT, 06904-0120, US

(21) Appl. No.: 09/968,695

(22) Filed: Oct. 1, 2001

Related U.S. Application Data
(60) Provisional application No. 60/236,995, filed on Sep. 29, 2000.

(51) Int. Cl. G06F 17/60

(52) U.S. Cl. 705/37

(57) ABSTRACT

An interactive system which provides customers with comprehensive information about a plurality of automobiles and any associated customizable features, collects customer requirements and preferences for an automobile and its customizable features, and provides a forum for conducting a reverse auction where sellers of products matching those sought by the customer bid for that customer's business. The system permits a customer to review a number of available products which exactly or closely match the desired item to narrow the scope of the search prior to the involvement of any representative of the seller.

### CROSS-REFERENCE TO RELATED APPLICATION(S)

The subject application claims the benefit of commonly owned, co-pending U.S. Provisional Application Ser. No. 60/236,995, filed Sep. 29, 2000, the disclosure of which is herein incorporated by reference.

### BACKGROUND OF THE INVENTION

1. Field of the Invention

The subject invention is directed to a system and method for soliciting bids for a customized automobile from a plurality of car dealers over a distributed computing network.

2. Background of the Related Art

The modern automobile customer is faced with an overwhelming array of choices for not only car models and options, but also from which to buy them. Dealerships sometime sell multiple automobile lines under one roof. Therefore, even if the customer begins shopping with a particular price range, automobile type, or manufacturer in mind, there remains a number of choices and decisions that still need to be made.

Whether a new or used vehicle is sought, the process typically includes educating oneself by reading various publications containing motor vehicle comparisons and reviews, such as Consumer Reports, determining the vehicle and associated features desired, and setting out to make personal visits to multiple auto dealer/retailers to find the vehicle matching the desired features.

Typically, the customer visits a dealership and wanders the showroom or the dealer's lot in search of the vehicle. The customer will soon discover that each vehicle, depending on the features sought, may or may not be available from several different dealers at any given time. The customer does not have any information concerning current dealership inventory. The customer may be approached by a salesperson who will provide assistance to the customer in locating and identifying the desired make and model. However, this process can be time consuming, particularly if the customer is unsure of their needs.

Even when or if the desired vehicle is found, the buyer will not immediately engage in a transaction with the dealer. Being aware that the traditional practice in auto sales is for the dealer to quote a high price and in doing so expects negotiations to ensue, the buyer will engage in what is widely-considered as an unpleasant haggling process until an agreement on price is reached. This may take considerable time and effort as each seller may be willing to sell its vehicles at different prices, depending, for example, on market conditions and time of year. A buyer's preference for certain available options or add-ons, typically included in conjunction with negotiations over the selling price, further complicates matters.

The process of locating and buying a used car may be even more cumbersome. Used cars of a particular line may be found at many more dealerships than just those of that particular line. It follows that the customer has an even larger number of potential trips to make to examine cars. Shopping for used cars using newspaper advertisements can also be very time intensive and ultimately disappointing. Newspaper advertisements typically provide only bare-bones information and do not provide a visual image of the automobile to give some indication of its condition.

In addition to being time-consuming and even irritating, the conventional process of purchasing a new or used vehicle makes it unlikely that the average buyer, or even the more sophisticated buyer, will truly obtain the best price.

Modern technological advances have eased the process of procuring and purchasing products of most kinds. Widespread use of personal computers, modems and data connections has allowed the growth of computer networks. The Internet serves as an example of a type of computer network, and indeed, is a large network of networks, all inter-connected, wherein mail, file transfer, remote log-in and other services are offered. The Internet uses a client-server architecture which is a network-based system that uses client software running on one computer to request a specific service, and uses corresponding server software running on a second computer to provide access to a shared resource managed by the second computer. The second computer then connects to the Internet, which provides the specific service requested.

In 1989 the World Wide Web (hereinafter “WWW” or the “Web”) was developed by English computer scientist Timothy Berners-Lee to enable information to be shared among internationally dispersed teams of researchers at the European Organization for Nuclear Research. The Web is an application program which runs on individual computers and creates connections to multiple different source computers over one or more networks. Web files are formatted using Hypertext Markup Language (HTML) and Web communications occur using the Hypertext Transfer Protocol (HTTP). The Web is a component of the Internet which allows Internet addressable resources to be connected to one another. The concept of connectivity was originally conceived by Ted Nelson in the mid 1960s as a method for making computers respond to the way humans think and require information. In Web parlance, the Web connections are called links or hyperlinks. The server that contains the files is called a Web site. Web sites contain documents of which a page is called a Web page. Web pages are displayed on a computer screen as agglomerations of text or images with sounds. On Web pages, hyperlinks may be displayed as text, typically in blue, or as a graphic icon. Users operating client computers interact with the Web by utilizing application programs known as Web browsers. When connected to a Web site, users, e.g., clients interact with Web pages by using a mouse and pointing and clicking on visual objects on the screen.

The Internet is growing exponentially and becoming an essential component of commerce in everyday life. Businesses are utilizing it to access and distribute information and increase communication both internally and externally with intended consumers. The growth and increasing availability of the Internet has led to the establishment of computerized shopping systems which provide a means for transacting business with the many consumers who have the ability to connect to the Internet.

The online “catalog” model of computerized shopping systems was the first to be developed. The first electronic catalogs were developed by suppliers to help customers obtain information about products and order supplies electronically. These first electronic catalogs were single-source, that is, they only allowed customers to obtain information and products from that one supplier. However, customer dissatisfaction at being locked in to one supplier, and desire to compare a number of competing products to be sure of getting the product features they wanted at the best price, resulted in the expansion of single-source electronic catalogs to include competitors' products on their systems. Eventually, electronic catalog sites became electronic markets run by third party non-suppliers. These markets offer consumers the opportunity to peruse and compare a variety of products and services before making a purchase.

For many standard products and services, the customer's needs have been met by such electronic catalog markets. The markets make it convenient to order products, because the ordering can be done without a personal visit, a telephone call, or a written communication, but such electronic shopping services have been limited to filling orders for products known in advance to the customer. Thus, the catalog type of electronic market does not work in some situations. If the required product is custom or customizable, it is not possible for suppliers to publish a set price for a catalog market. The catalog market does not provide much help to the buyer who is not sure about the products available, and their features, but who wants to search for products having the lowest price and which satisfy personal preferences. Furthermore, the consumer must still seek out the desired product and suitable products for comparison purposes. Thus, the catalog type market is not well-suited for selling products such as motor vehicles, where there are base models with many possible and obtainable options and variable pricing depending on the base model and options sought. There is also no suitable means for offering to the consumer a reasonable alternative from the original product sought, which is especially important in motor vehicle sales because some motor vehicles include options which are not available at the retail level (for example, the interior and exterior colors), and therefore, an alternative may be all that is currently available from the dealer.

Electronic exchange markets provide another means for addressing this type of sale of customized goods over the Internet. There are two basic structures for exchange markets. One form of exchange market is an auction market where one seller solicits bids from multiple buyers. A noteworthy example of the buyer-bidding auction model is that described in U.S. Pat. No. 5,794,207 to Walker et al. In this system, potential buyers compete for airline tickets by submitting a bid for an airline ticket on a website, and airlines can choose to accept a bid, thereby committing the buyer to buy the ticket. U.S. Pat. No. 4,789,928 to Fujisaki discloses an auction information transmission processing system which enables individuals dispersed over a wide area to participate in an auction without gathering at the auction site via computer networks. Fujisaki also describes the auctioning of used cars or the like.

Fujisaki and the buyer-bidding auction types of electronic markets do not work in some situations, particularly where the products are motor vehicles which are customizable by the buyer prior to purchase. It is not possible for buyers to select the product they want to bid on in a buyer-bidding auction. The buyers must either wait until the product they desire is put up for auction or settle for another product. Also, there is no standard product and pricing information available for the buyer. Furthermore, in an environment where buyers compete for a limited amount of products, some buyers will leave empty-handed.

Another form of exchange market is an auction market where one buyer solicits bids from multiple sellers. In a seller-bidding auction, bid prices start high and move downward in reverse-auction format as bidders interact to establish a closing price. An example of this type of market is described in U.S. Pat. No. 6,230,147, issued to Alaia, et al., which discloses a method and system for controlling various parameters in an electronic seller-bidding auction, such as closing times and bid limits. The method disclosed by Alaia, et al., is best-suited for industrial buyers of lots consisting of families of similar components which are already known to the buyer. This system does not provide information regarding various products and options and a means for buyer-customization of those products prior to the actual auction.

The problems with the prior systems make it especially difficult to engage in motor vehicle transactions via electronic commerce. Of course, any problems experienced by buyers which detrimentally effects a potential transaction, becomes a seller's problem as well. In addition to not providing the customer with detailed information about available models and features, some customers may prefer to make their selection alone in the absence of any sales pressure from an employee of the dealership. The dealership may also benefit from this preference by not having a salesperson tied up with a customer who is unsure of what he wants. The dealership and the customer will most benefit from involving the salesperson at a point where the customer knows what he wants.

The systems described above do not address these problems yet there is a strong need for a better system. For example, of the $400 billion in automobile sales in the United States in 1999, 2.7 percent of new vehicles were sold over the Internet. By the year 2003, it is expected that consumers will purchase approximately 500,000 new cars over the Internet.

The present disclosure provides a solution to the problems associated with prior art systems, by using the Internet to facilitate motor vehicle sales in an uncomplicated manner which saves time, effort and money for both the dealer and customer.

### SUMMARY OF THE INVENTION

An interactive system is disclosed which provides customers with comprehensive information about a plurality of products and any associated customizable features, collects customer requirements and preferences for a particular product and its customizable features, and provides a forum for conducting a reverse auction where sellers of products exactly or closely matching those sought by the customer bid for that customer's business. The system permits a customer to review a number of available products which exactly or closely match the desired item to narrow the scope of the search prior to the involvement of any representative of the seller.

The preferred embodiment of the present disclosure is directed to an interactive system and method for customizing an automobile through an interactive online automobile configuration program, which may be electronically integrated and compared with dealers' inventory, and subsequently soliciting bids for the customized automobile from a plurality of automobile dealerships over a distributed computing network.

These and other unique features of the system and method disclosed herein will become more readily apparent from the following description of the drawings.

### BRIEF DESCRIPTION OF THE DRAWINGS

So that those having ordinary skill in the art to which the disclosed system and method appertains will more readily understand how to employ and use it in its preferred embodiment, reference may be had to the drawings wherein:

FIG. 1 is flowchart depicting the user interface with a system constructed in accordance with the preferred embodiment of the present disclosure;

FIG. 2 is a sample web page that may be encountered by a user while choosing the year, make and model of an automobile the user desires to purchase in accordance with the preferred embodiment;

FIG. 3 is another sample web page that may be encountered by a user while choosing a level of trim for an automobile in accordance with the preferred embodiment;

FIG. 4 is another sample web page that may be encountered by a user while selecting interior and exterior colors for an automobile in accordance with the preferred embodiment;

FIG. 5 is another sample web page that may be encountered by a user while choosing options and packages for an automobile in accordance with the preferred embodiment;

FIG. 6 is another sample web page that may be encountered by a user while viewing the price of the user-configured automobile in accordance with the preferred embodiment;

FIG. 7 is another sample web page that may be encountered by a user while indicating the user-preferred criteria in accordance with the preferred embodiment;

FIG. 8 is another sample web page that may be encountered by a user while providing contact information in accordance with the preferred embodiment;

FIG. 9 is a sample database table for storing user access information which may be utilized in accordance with the preferred embodiment;

FIG. 10 is a sample database table for storing user contact information which may be utilized in accordance with the preferred embodiment;

FIG. 11 is a sample database for storing car configuration information which may be utilized in accordance with the preferred embodiment;

FIG. 12 is a sample web page that may be encountered by a user while providing a deposit in accordance with the preferred embodiment;

FIG. 13 is a sample database table for storing promotion information which may be utilized in accordance with the preferred embodiment;

FIG. 14 is a sample web page that may be encountered by a user when making a bid request in accordance with the preferred embodiment;

FIG. 15 is a sample database table for storing auction information which may be utilized in accordance with the preferred embodiment;

FIG. 16 is a sample database for storing dealer information which may be utilized in accordance with the preferred embodiment;

FIG. 17 is a flow chart depicting the dealer interface with a system constructed in accordance with the preferred embodiment of the present disclosure;

FIG. 18 is a sample database for storing bid information which may be utilized in accordance with the preferred embodiment;

FIG. 19 is a flow chart depicting the user login interface with a system constructed in accordance with the preferred embodiment of the present disclosure;

FIG. 20 is a sample web page that may be encountered by a user when checking for bids in accordance with the preferred embodiment;

FIG. 21 is a sample web page that may be encountered by a user when comparing bids in accordance with the preferred embodiment;

FIG. 22 is a sample web page that may be encountered by a user when accepting a bid in accordance with the preferred embodiment;

FIG. 23 is a diagram illustrating some of the managerial and administrative functions in a system constructed in accordance with the preferred embodiment; and,

FIG. 24 is a diagram illustrating the connections between the databases which may be used with the preferred embodiment.

### DETAILED DESCRIPTION OF THE PREFERRED EMBODIMENTS

The present disclosure provides a novel and unique system for facilitating a reverse auction of customizable products. It is understood that its use in conjunction with motor vehicle sales is exemplary of the type of product and circumstance for which the present disclosure is well suited. Those skilled in the art will readily appreciate that a system in accordance with the present disclosure may be used in conjunction with other products as well.

Those skilled in the art will also readily appreciate that a system in accordance with the present disclosure includes the various computer and network related software and hardware used in a distributed computing network, that is, programs, operating systems, memory storage devices, data processors, servers with links to data communication systems, wireless or otherwise, such as those which take the form of a local or wide area network, and a plurality of data transceiving terminals within the network, such as personal home computers. Those skilled in the art will further appreciate that, so long as its users are provided local and remote access to a system in accordance with the present disclosure, the precise type of network and associated hardware are not vital to its full implementation.

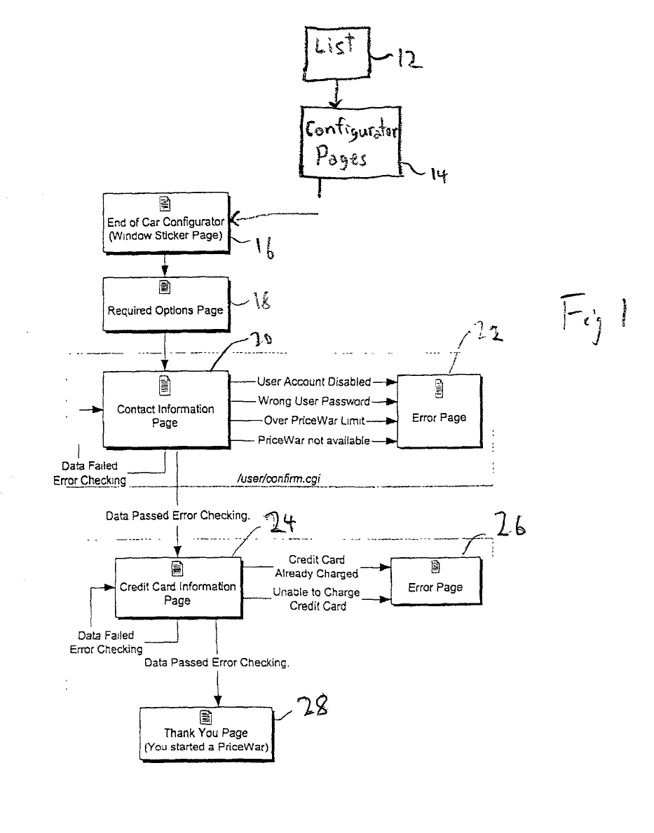

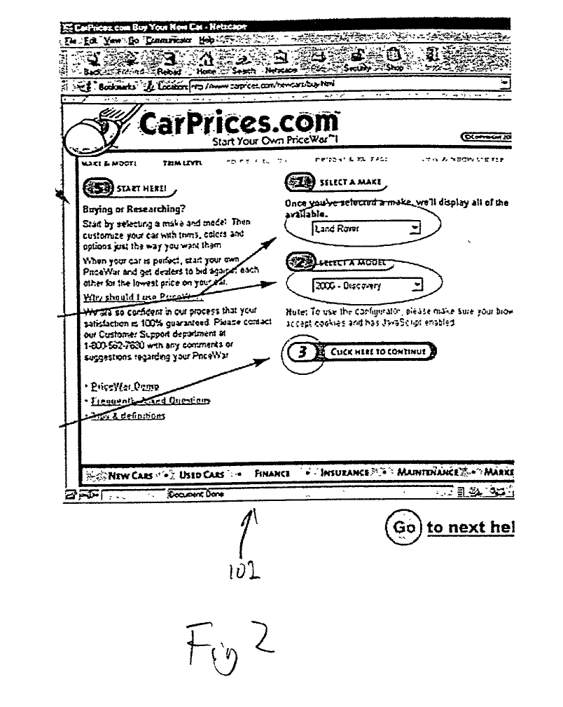

Referring now to the drawings, wherein like reference numerals generally identify similar elements of the present disclosure, FIG. 1 illustrates the initial user interface with a system 10 constructed in accordance with the present disclosure. In step 12, a user employing system 10 (hereinafter referred to as “the user” or “Buyer” or “customer”), is provided with a list of automobiles available and vehicle specifications, such as horsepower, interior space, miles per gallon, etc. Further information such as auto reviews or links to such further information may also be provided in this step. Once a make and model of vehicle is chosen, by either entering data into specific fields or using pull-down menus as shown in sample web page 102 in FIG. 2, the user is given the information and opportunity to configure the associated options, add-ons or features of the chosen automobile in step 14.

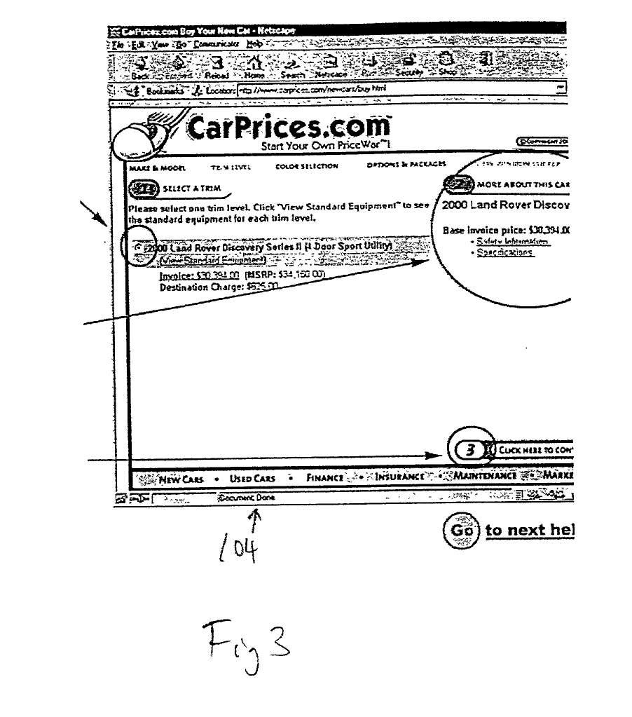

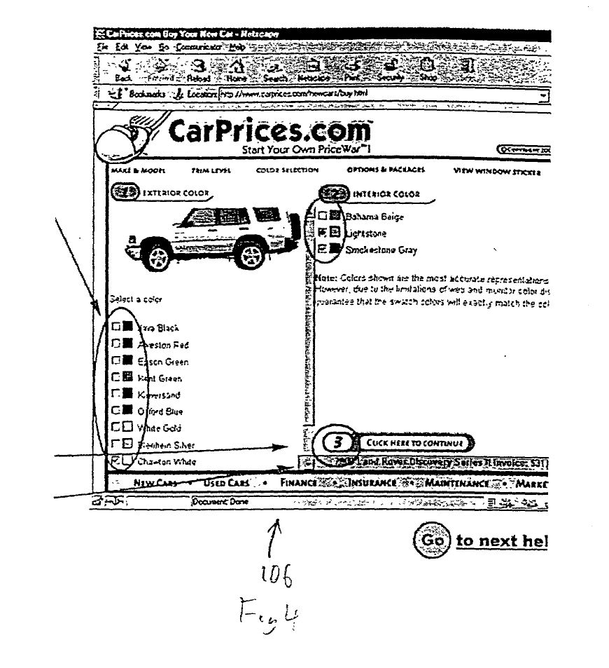

The configuration program (or “car configurator”, as it is alternatively referred to herein), in step 14 may consist of a series of interactive web pages presenting a sequence of methodical steps for customizing a new vehicle. For example, to begin the vehicle configuration process, the user selects a year, make and model for the desired vehicle and then selects a level of trim by clicking on the corresponding button located on the web page. This is illustrated in sample web page 104 shown in FIG. 3. Trim level refers to the varying equipment that may be selected for a particular car. At such a time, information is displayed on the web page about the car of choice, and links are provided which may be may be selected by the user to open other web pages in the browser to provide additional information about the trim level chosen. The user next selects the exterior color of the vehicle by clicking on the corresponding check box displayed on the web page, as illustrated in sample web page 106 in FIG. 4. The most accurate representation of the color is displayed. Similarly, the interior color is selected by clicking on an appropriate check box. The system will not proceed to the next step until the exterior and interior colors have been selected. From this point on in the program, the invoice price of the car being configured is displayed at the bottom of each web page. The invoice price will change as further options are added to the vehicle.

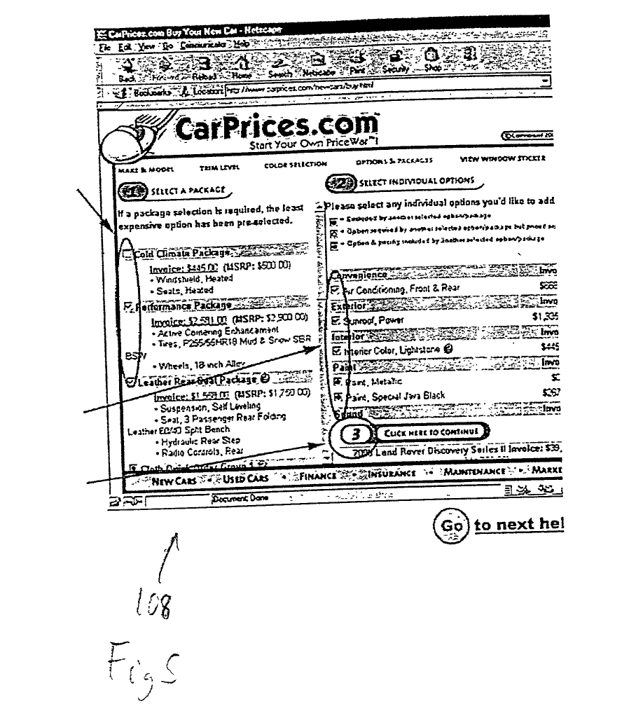

The user then selects the option packages that are available for the particular car being configured. This may be accomplished by clicking on a number of corresponding check boxes as illustrated in web page 108 in FIG. 5. For example, the types of options may include a cold weather package with heated windshield and heated seats, or a performance package with active cornering and alloy wheels, among other things. The configuration program used in step 14 does not permit the user to choose multiple packages if they are conflicting with each other. For example, the program will not allow the user to select a cold weather package and a warm weather package. The user may also select individual options or features for the car by clicking on a set of corresponding check boxes. For example, the user may select such features as air conditioning, power sunroof, or metallic paint. In each instance the suggested retail price is indicated for each feature. And, as stated above, for each package and individual option selected by the user, the invoice price displayed at the bottom of the web page is updated.

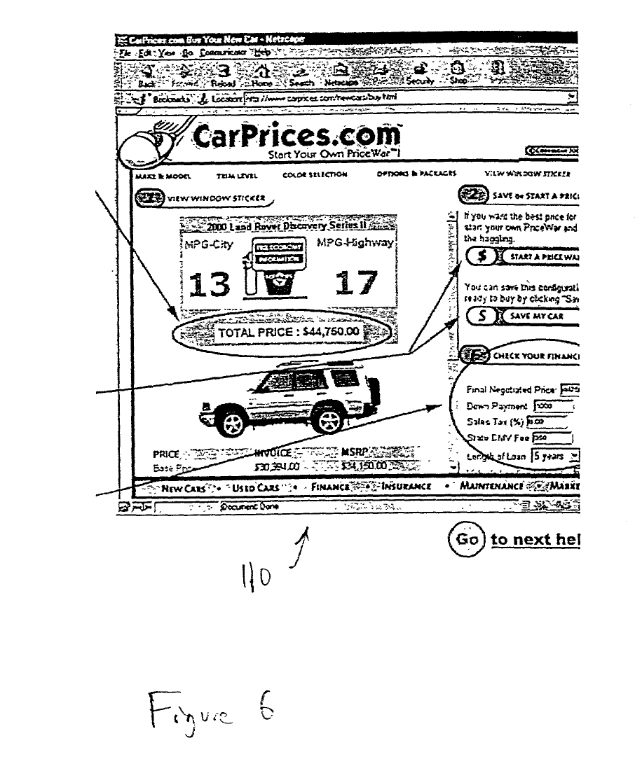

Upon completion of the configuration step 14, a depiction of the vehicle window sticker is displayed in step 16. An example of window sticker page 110 is shown in FIG. 6. Window sticker page 110 shows the total price of the car based upon the way in which the user configured the vehicle. Both the invoice price and Manufacturer's Suggested Retail Price (“MSRP”) may be shown. The prices are intended to give the user an approximation of the bids he or she should expect to receive from the participating dealerships. If, at such a time, the user is satisfied with the configuration of the car, they can either save the configuration for a later time, or submit the configuration for bidding. If the user decides to save the configuration, the user is issued a registration number, and they can utilize the number to retrieve their configuration at a later date by logging onto a particular web site. In a preferred embodiment of the present disclosure, the user may utilize a calculator displayed on the web page to determine estimated monthly payments for the vehicle based upon particular financing arrangements. These calculations will not be binding upon the user.

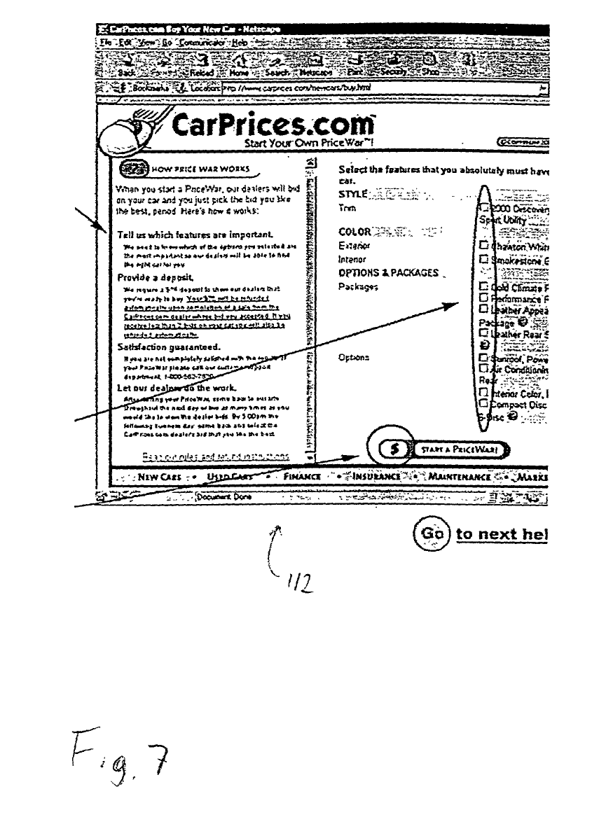

In Step 18 and as shown in sample web page 112 shown in FIG. 7, the user is asked to check the features that their car absolutely must have. It is explained to the user that the more flexible they are with the features they have selected, the greater the chance a dealer will have a car that matches their needs. To set the preferential order of importance, the user may click on check boxes in web page 112 corresponding to each of the packages or features they had previously selected during the configuration process. This may also be set up in a manner which allows for the placement of numerical values in an order of the most desired to the least of the chosen criteria. As also illustrated in web page 112, the user is provided with a detailed explanation of the method of conducting the bidding process by displaying a set of rules. In this embodiment, the user is required to provide a deposit which will be refunded when a sale is completed with an authorized dealership. The deposit may also be applied to the cost of the motor vehicle when a sale is completed.

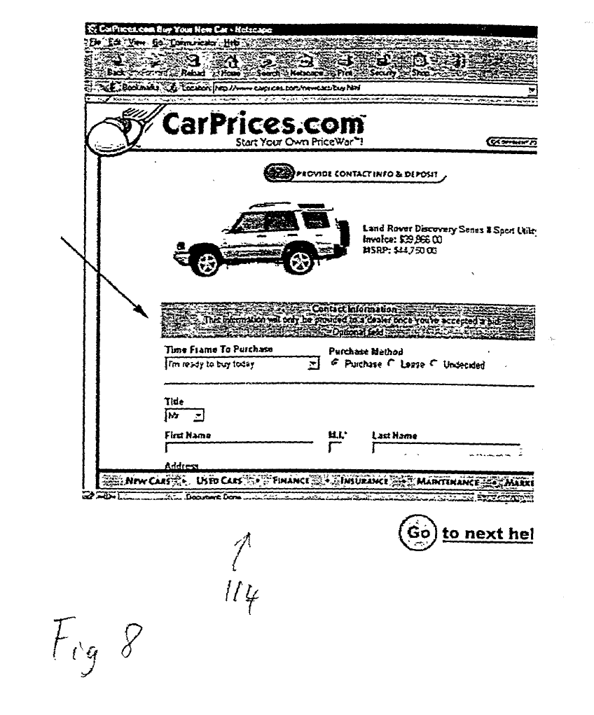

In step 20, the user is prompted via another web page to provide information about themselves and contact information by inputting data into a plurality of specific fields of a database record. This information will be used to set up a membership account with system 10 for the user making it easier for the user and seller/dealer to engage in a transaction. The information will be stored in a memory device to provide the user with continued access to system 10 after exiting without having to reenter such information again. FIG. 8 illustrates a sample contact information web page 114. Preferably this information, which may include data such as user name, mailing address, phone number and e-mail address, will only be provided to a dealer once the user has selected a bid.

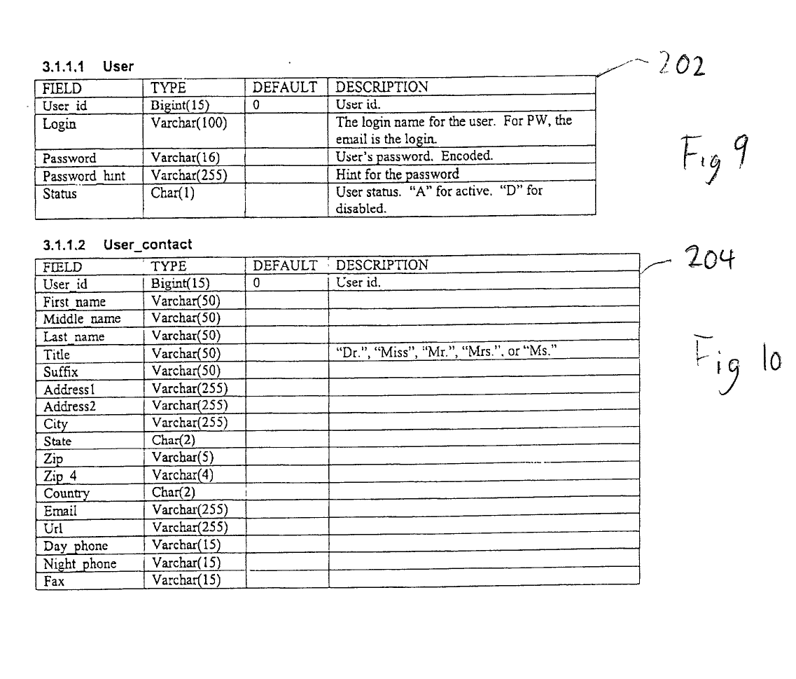

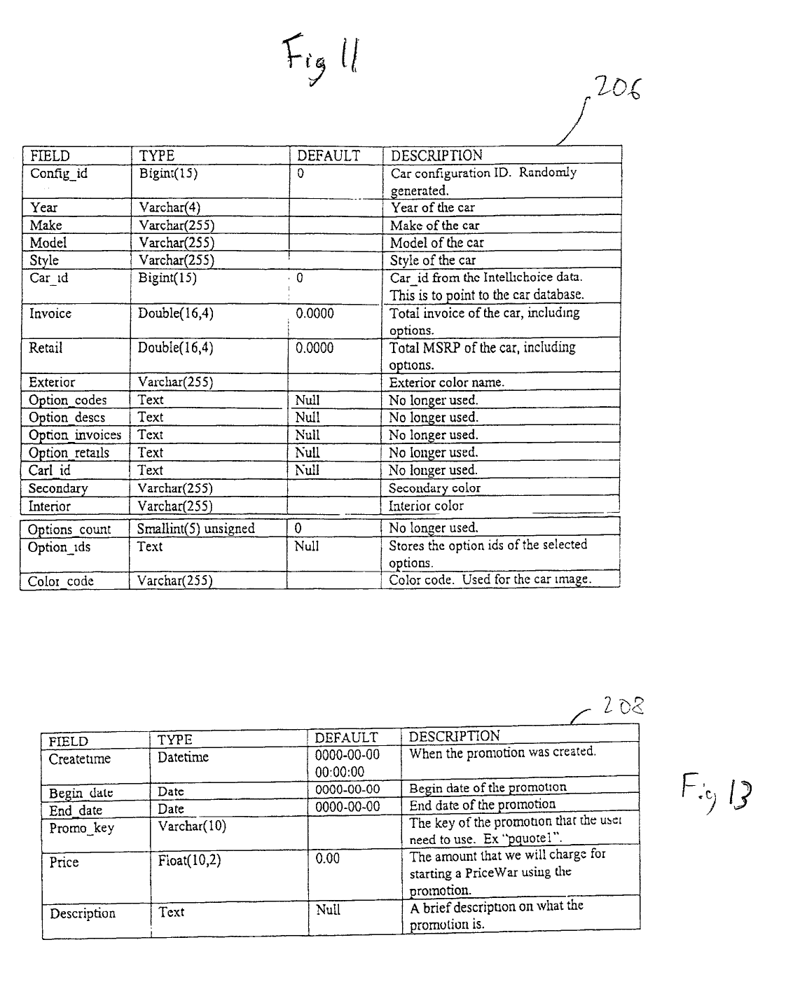

FIG. 9 illustrates a sample membership table 202 for collecting the user information in various fields accepting alphanumeric input. A user identification is assigned along with a login name, such as the user's email address, and encoded password for continued access to system 10. Preferably, and as shown in table 202, a password hint field and status, designating whether the user's account is active or active, are also included. FIG. 10 illustrates a sample membership table 204 for collecting the user contact information. Various fields record the user's name, address, email, web site address or URL, and fax, day and night telephone numbers. Other information regarding the user, such as demographic information about the user (i.e., personal preferences, likes, interests, etc.) may also be collected in similar tables for future marketing and/or promotional advertising.

In addition, the user may also be prompted to provide a time frame for the purchase, for example, within a certain number of days, as well as the method by which the purchase will be made, such as, by direct purchase, financing or lease.

Preferably, system 10 performs a validation check of the inputted contact and credit card information. If the data inputted into the various fields is incorrect or in an unrecognized format, the data will be rejected and the form will redisplayed to the user with the problem field highlighted. Once the data passes the error checking portion, it is inserted into the database. User contact information will go into tables 202 and 204.

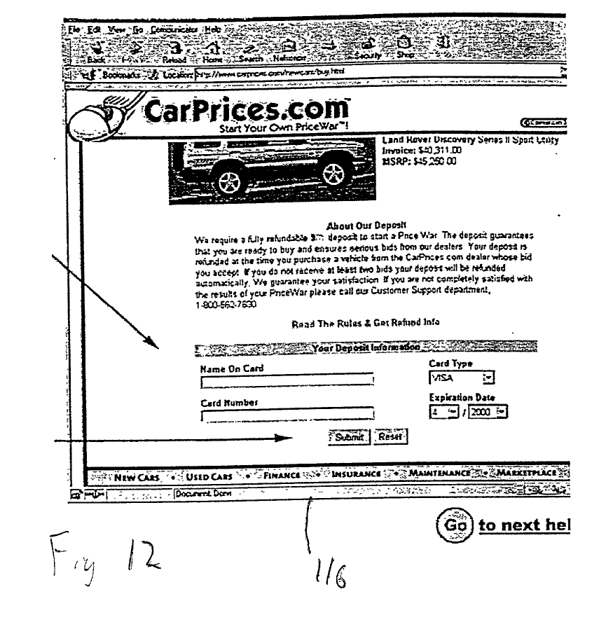

At this time, car configuration data chosen by the user in step 16 is stored in the database in a “mycar” table 206 illustrated in FIG. 11. Also, an auction iteration is run and given “invalid” status. Preferably, and as shown in Table 206, a car configuration identification is assigned to each particular configuration data. Table 206 stores basic information about the desired motor vehicle such as its make, model, year, style, invoice price, MSRP price, secondary color and interior color.

After the information is successfully captured in the system 10 database, a “mymember” cookie is also set with the user identification as the value. This enables the user information to be pre-loaded if necessary.

Besides the basic data validation, there are some conditions that will prevent a user from participating in an auction, such as if the user is over the auction limit. Preferably, the user is allowed a max of three auctions within 90 days, and one auction per day. Other conditions which may prevent access include incorrect password entry, account status disabled, or if the auction is limited geographically and unavailable in the user's area. Any of these result in an error page being displayed, as shown by step 22.

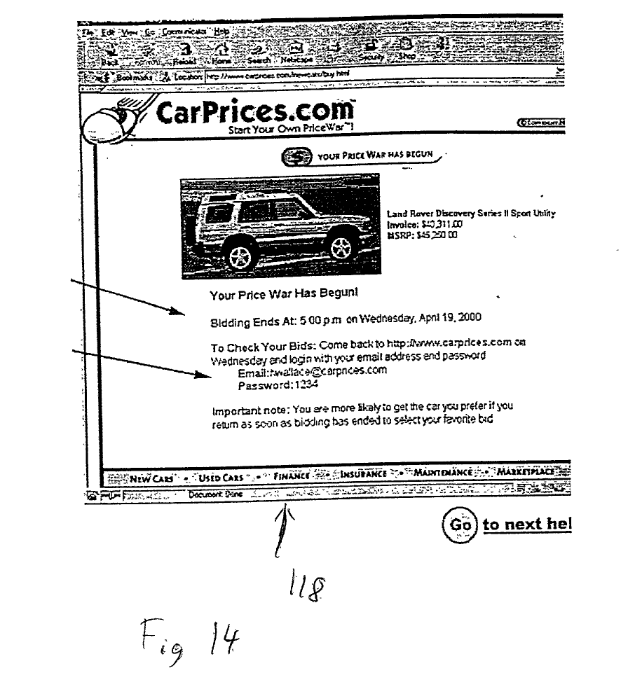

Next, a secure form for providing credit card information is displayed to the user in step 24 as shown in sample web page 116 in FIG. 12. The deposit may also be supplied or simply checked through an Internet payment service such as CyberCash. Preferably, the user may also input special promotion codes into page 116 that allow special access to system 10, such as with less deposit for example. Table 208 in FIG. 13 illustrates a database for storing special promotion data. The form in page 116 has some basic error checking and an error message or page will be displayed to the user in step 26 of FIG. 1. For example, errors will result if the user's credit card has already been charged or if the deposit is not received or verified by the credit card company or payment service. Page 116 will be displayed again to the user with the problem areas highlighted for correction. Once the inputted data passes error checking and the credit card is successfully charged, the “invalid” auction status changes to “active”.

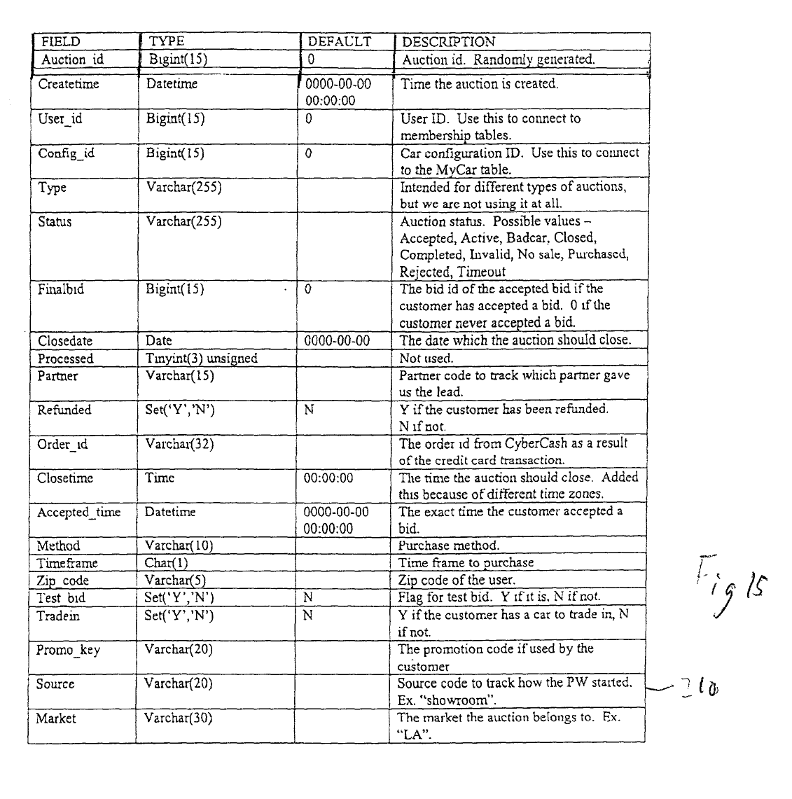

Once the initial setup process is complete (i.e., all data passes error checking and deposit is secured) the user is offered the opportunity to go back to step 14 to reconfigure the current configuration for the desired car or back to step 12 to chose a different motor vehicle to configure. Otherwise, the user is offered the opportunity to submit the current configuration for bidding and proceeds to step 28 and sample web page 118 is displayed informing the user that a “PriceWar” (“PW”) has begun, as shown in FIG. 14.

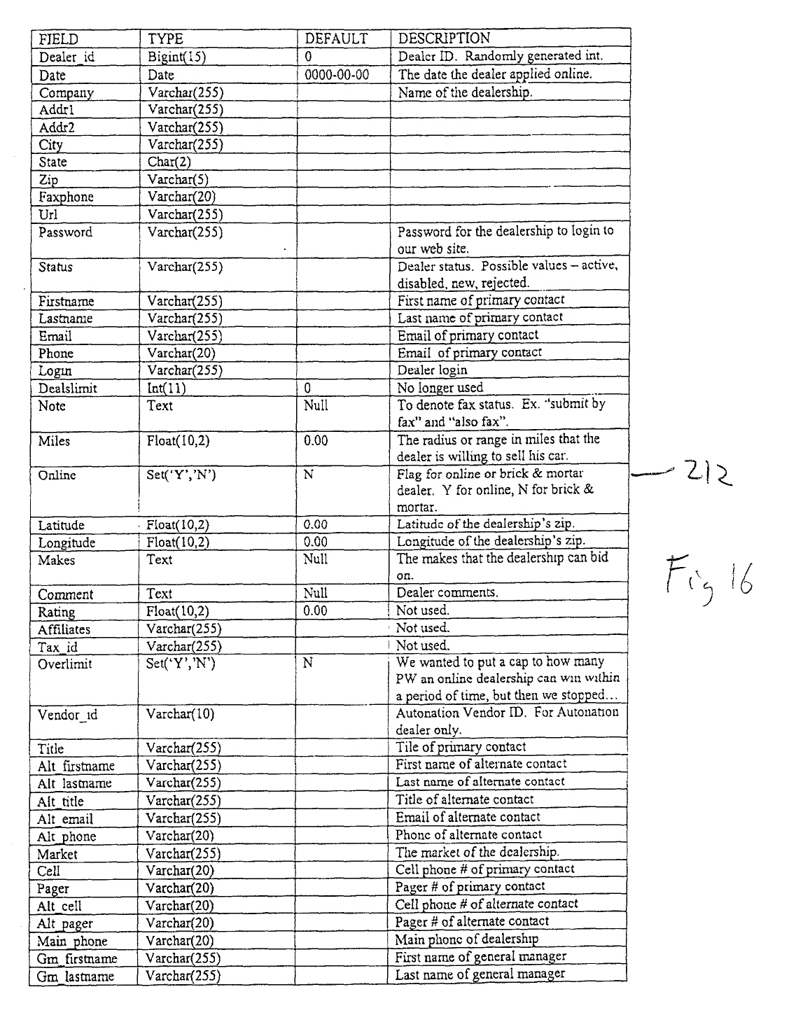

At this point, requests for new bids are transmitted, preferably via electronic mail, to notify the system support group and the participating dealers. A confirmation message is also transmitted to the user. An auction identification is generated and data regarding the auction is stored in table 210 in FIG. 15. Table 210 may store information regarding the user, car configuration, auction status, closing dates and time, purchase method and final bid information if the bid is accepted, among other things.

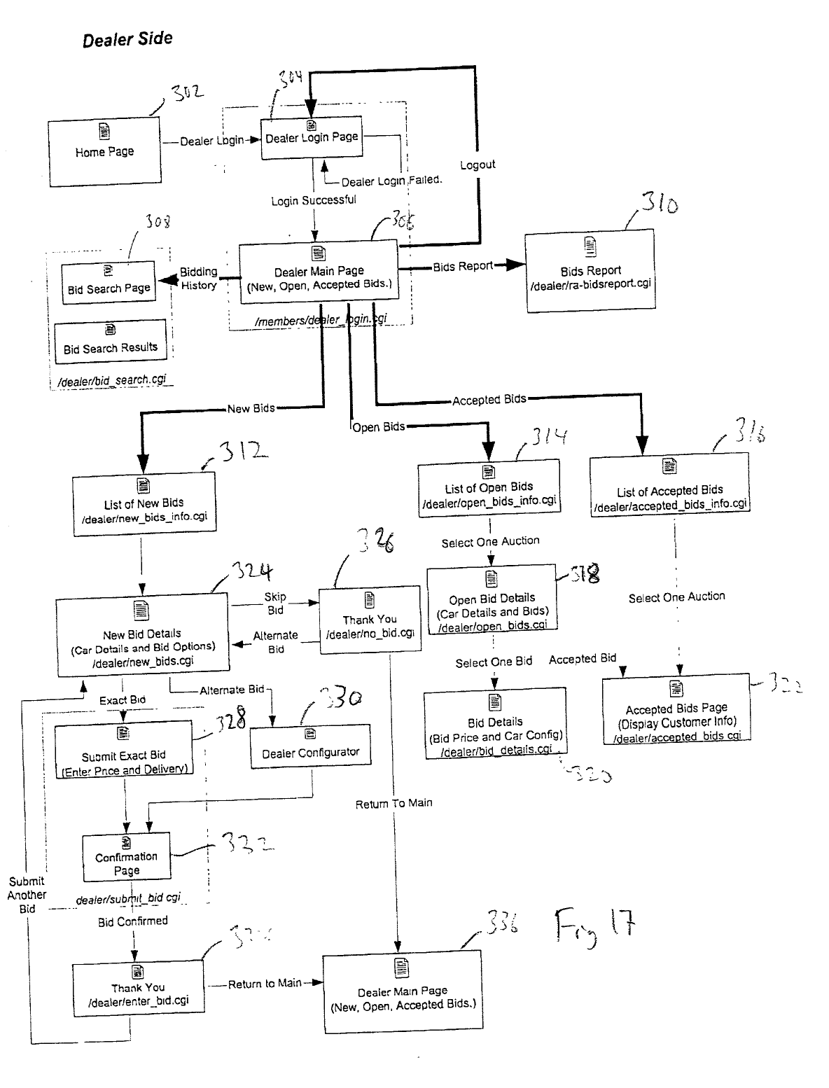

Table 212 in FIG. 16 stores information regarding participating dealers. This information may include contact information, the amount or type of cars available, makes the dealer can bid on, whether the dealer is an online merchant or maintains a physical dealership, and the dealer's geographical limitation (i.e., the geographical range or areas in which the dealer is willing to sell cars), which may by radius in miles and zip code. Preferably, the requests for bids are sent to the appropriate dealers for the user's location and car, based on the information in table 212.

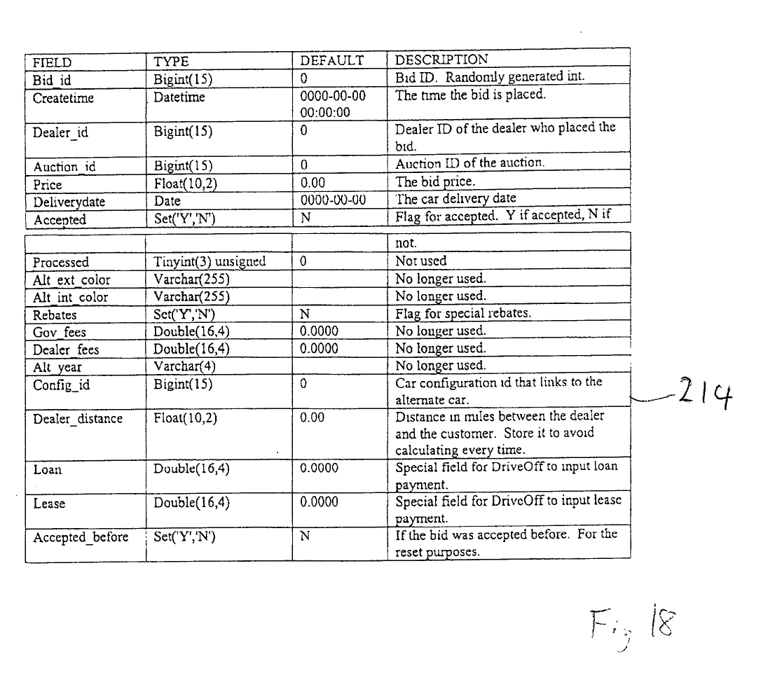

FIG. 17 illustrates the PriceWar (i.e., reverse or seller-bidding auction) process from the dealer's perspective. After receiving notification of a new bid request, the dealers enter their own identification numbers and login passwords in the system 10 home page, as shown in steps 302 and 304. If the login is successful, the dealer is directed to the dealer main page in step 306 where the dealer may perform various tasks, such as search and review bidding history in step 308, generate bidding reports in step 310, review the new bid request(s) in step 312, as well as check the status of any open, accepted, or previously existing auctions, bids or bid requests in steps 314 and 316, via a series of web pages. The web page in step 314 illustrating the open bids provides an opportunity to obtain further details, by auction and/or bid, regarding the car configuration and bid prices of each open bid, in steps 318 and 320. Open bids are bids made in an auction where the user has not indicated acceptance of any bid. Bids where Dealers offer the exact match of the vehicle requested or a close match are allowed. Where a close match is offered to the user a screen describes to the user the material differences in the requested vehicle and the closely matching vehicle. Once a bid is accepted by the user, the bid becomes an accepted bid for the dealer that submitted the bid, and the open bid is removed from the other dealer's open bid list. The open bid information allows the dealers to see which auctions they have a bid on and still have a chance to win.

Similarly, the page in step 316 provides an opportunity to obtain further information regarding accepted bids in step 322, such as, user information for the user that has demonstrated their acceptance of the bid.

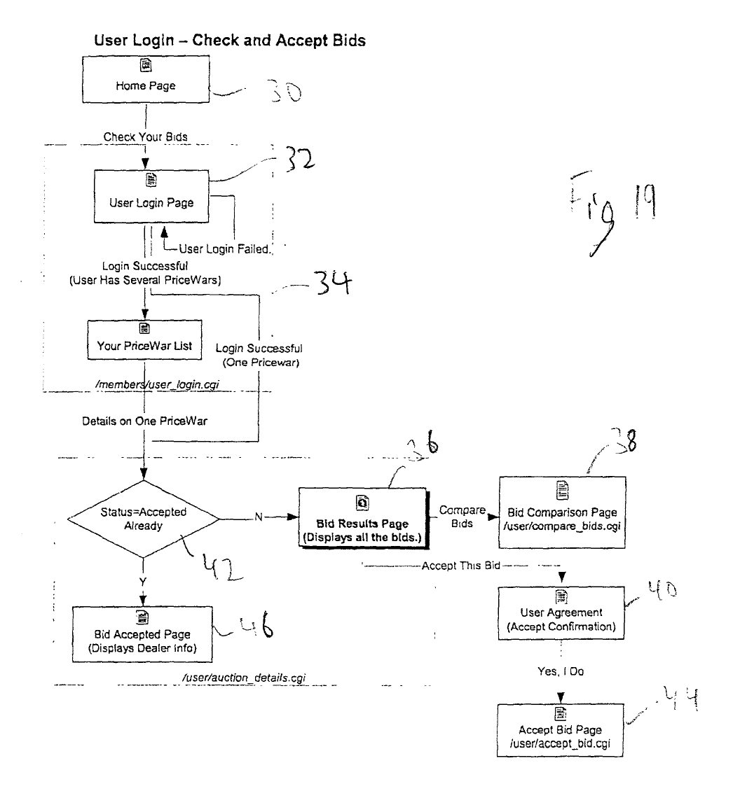

From the new bids page in step 312, the dealer can obtain the bidding closing time and review further details regarding the exact car configuration (i.e., make, model, interior and exterior colors, options, preferences, etc.) in step 324. At this point, the dealer may choose to not make a bid as shown by step 326, submit a bid for a car that matches exactly with the configured car in step 328 or submit a bid for a similar car in step 330. Submitting a bid for a similar car in step 330 directs the dealer to the dealer configurator which allows the dealer to configure a different car to place a bid on. Preferably, the features and options the user indicated as being required in step 18 are preselected so that the dealer configurator is a minimized version of the car configurator in step 14. This saves time and also prevents any confusion from a dealer submitting a bid for a car which is vastly different from the one in the user's bid request. Once the bid price and date of delivery is confirmed in step 332, the information is stored in a database table in system 10, such as table 214 shown in FIG. 18, along with a bid identification and information including the dealer identification, auction identification and bid status.

If no errors occurred during the process, a “thank you” page is shown in step 334. Some error conditions which might occur include when the bid price and delivery date are not in the right format or if the auction has closed. Each dealer is allowed a maximum number of bids for any one request. Preferably, the maximum bids for each request is three. If the dealer placed less than the maximum number of bids for that request, the “thank you” page in step 334 will have additional hyperlinks back to the new bid page in step 324 to let the dealer place more bids. The dealer may also return to the dealer main page in step 336 which would now provide updated bid information.

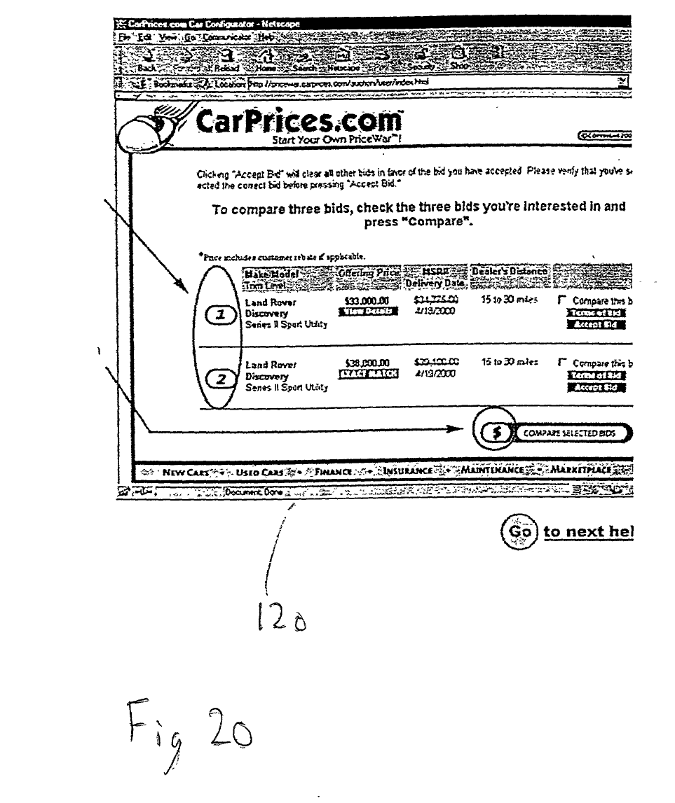

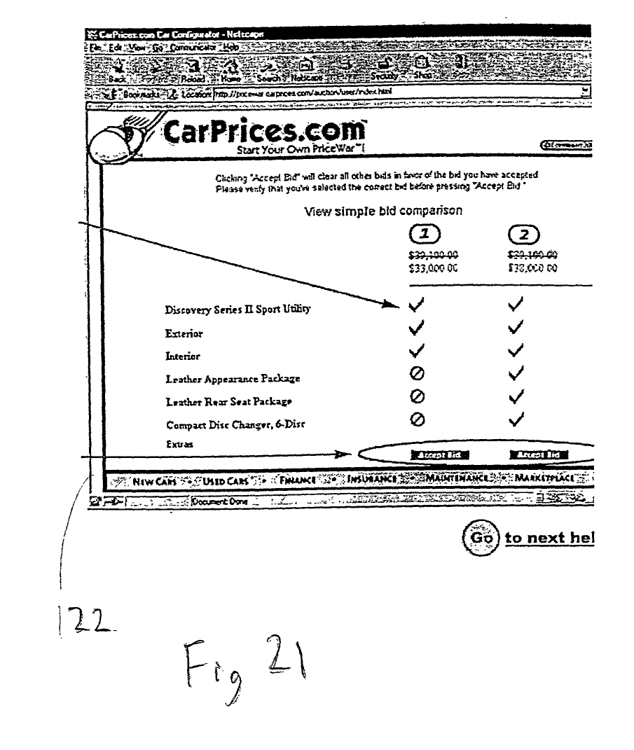

Step 30 in FIG. 19 illustrates the steps for the return of the user who has successfully initialized an account and requested a bid to the home or first page of system 10. After submitting the necessary identification and correct corresponding password in the login page in step 32, the user is provided with a page in step 34 listing the user's bid requests or “PriceWars.” If the user has made only one bid request, then preferably, the user is directed after login to a results page in step 36 listing all the bids. If the user submitted multiple bid requests, each bid request will have its own results page and the user must indicate which bid results to view in step 36. FIG. 20 illustrates a sample bid results page 120. Preferably, bids on cars which exactly match the criteria set by the user are highlighted or otherwise indicated as being such in page 120. Also, the bid results page provides an opportunity to e-mail the results to a friend, the details regarding the bids themselves, delivery dates and the process allowing dealers to submit bids for similar but not matching cars.

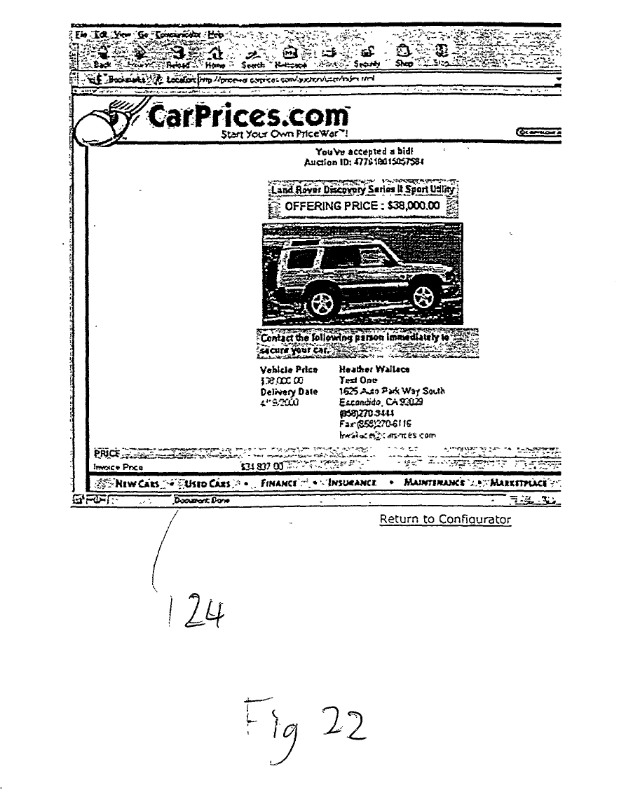

Preferably, and as shown in step 38, system 10 provides a means for comparing a plurality of the bids by listing all criteria in table format. An example bid comparison page 122 is shown in FIG. 21. The user may accept bids from page 120 or page 122. Once the user indicates acceptance of a bid, its contract terms and conditions are displayed to the user for his or her acknowledgment and confirmation in step 40 in FIG. 19.

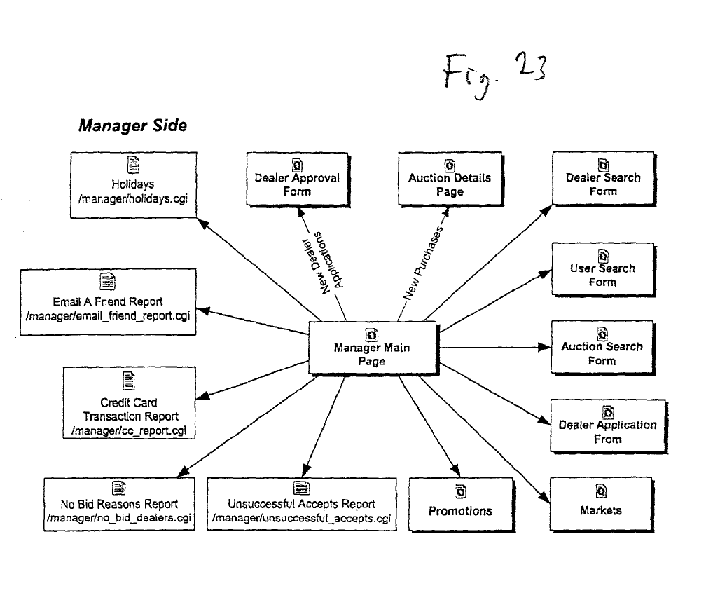

Preferably, if the user confirms acceptance for a bid in step 40, an error check is performed prior to updating the databases to reflect the acceptance of the bid. After the check is performed without incident, the bid is accepted, the bid acceptance status is changed to positive in step 42 and a bid acceptance page like page 124 in FIG. 22 is displayed in step 44. Dealer contact information is provided to the user and notification, preferably by electronic mail, of the acceptance is sent out to the user and dealer making the accepted bid.

If the user logs out and then logs back into system 10, according to steps 30 and 32, the user would be directed via the positive accepted bid status in step 42 to the bid accepted page in step 46 which displays information related to the accepted bid.

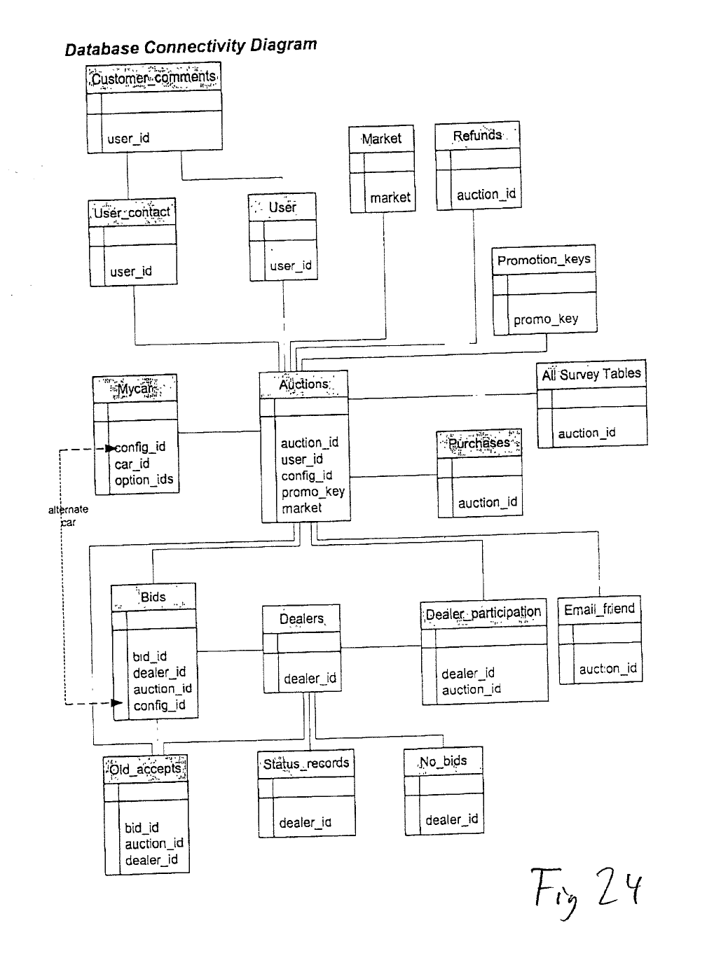

Some of the administrative and managerial capabilities of the system are illustrated by the chart in FIG. 23. Some of these functions include approving dealers and generating various reports regarding the use and features of system 10. As illustrated in FIG. 24, the many databases used to store system 10 information are operatively linked by the set of various identification codes for other databases, at least one of which is contained in each database. Preferably, one database becomes the central database in that it holds all the individual identifications. In this embodiment, the auction database contains all the identifications of all other databases containing further information involving this particular auction, such as the user, car configuration, dealer and bid databases.

The manager may also search through databases of auctions, dealers and users using different variables and make any changes necessary to correct user or dealer bidding mistakes, update system 10 features or information, or change auction parameters.

Administrative functions include running various programs to update or delete old information, send reminders to users and dealers, such as emails regarding auction closing times, acceptance or open bids, and surveying users and dealers to gather information which may be helpful for fine-tuning system 10 or for developing demographic statistics or promotional/marketing purposes.

In another embodiment of the present disclosure, system 10 would include dealer provided inventory data (i.e., amount of vehicles in various configurations) for all their automobiles, which would permit system 10 to automatically match the user's configured automobile with one from the inventory database. If the inventory database does not contain an exact match, an alternative car having a similar configuration would be displayed to the user. Preferably, any alternative cars would be ranked according to the percentage of features matching with the user's configuration. Also, the user may rank his or her preferences in sequential order of importance to ensure that the alternative motor vehicle would be more desirable.

In yet another embodiment of the present disclosure, system 10 would include dealer provided bidding data for all their automobiles in various configurations. This would permit system 10 to provide automatic bids from each participating dealer immediately upon the user's request for a bid, as long as the dealer was appropriate for the auction. This obviates the need for manual entry of bids from the dealers and greatly increases the speed of the transaction, among other things.

The system of the present disclosure offers many advantages over the traditional methods for automobile transactions. Although the preferred embodiments of the present disclosure have been described with a full set of features, it is to be understood that the disclosed system may be practiced successfully without using each of those features. It is to be further understood that modifications and variations may be utilized without departure from the spirit and scope of this inventive system, as those skilled in the art will readily understand. Such modifications and variations are considered to be within the purview and scope of the appended claims and their equivalents.

What is claimed is:

1. A method of auctioning motor vehicles and establishing a contract of sale over a distributed computing network, comprising the steps of:
(a) providing a prospective buyer with inventory data relating to a plurality of motor vehicles from which the prospective buyer selects a motor vehicle to purchase, wherein the inventory data further includes a plurality of customizable options for each motor vehicle in the plurality of motor vehicles from which the prospective buyer may selectively prefer one or more customizable options;
(b) receiving and storing buyer data in a database relating to the prospective buyer and the motor vehicle the prospective buyer selects to purchase;
(c) receiving and storing offer data in a database from the sellers relating to the motor vehicle the prospective buyer selects to purchase;
(d) communicating the offer data to the prospective buyer, the offer data including an offer to sell a motor vehicle to the prospective buyer at an offer price, wherein the offered motor vehicle is the same as the motor vehicle the prospective buyer selects and includes at least one customizable option that substantially correspond with at least one of the one or more customizable options selectively preferred by the prospective buyer;
(e) receiving and storing response data from the prospective buyer in a database, wherein the response data includes an acceptance or rejection of the offered motor vehicle at the offer price; and
(f) communicating the response data to the sellers.

2. A method according to claim 1, further comprising the step of submitting a monetary deposit prior to communicating the buyer data.

3. A method according to claim 1, wherein the inventory data is provided by a plurality of sellers of motor vehicles.

4. A method according to claim 3, wherein the inventory data includes an offer price for each motor vehicle having at least one customizable option.

5. A method according to claim 3, wherein the inventory data includes the numbers of each motor vehicle of the plurality of motor vehicles available for sale.

6. A method according to claim 3, wherein the offer data is communicated to the buyer after the buyer data is received and stored.

7. A method according to claim 1, wherein the buyer data is communicated to a plurality of sellers of motor vehicles.

8. A method according to claim 1, wherein the buyer data includes information relating to the time in which the buyer will buy the desired product and the method by which the purchase will be financed.

9. A method according to claim 1, wherein the offer data is communicated to the buyer within a predetermined period of time.

10. A method according to claim 1, wherein the response data is received within a preset period of time.

11. A system for selling motor vehicles and establishing a contract of sale over a distributed computing network, comprising:
(a) means for displaying a list of a plurality of different types of motor vehicles;
(b) means for enabling a selection of one type of motor vehicle from the list of a plurality of different types of motor vehicles;
(c) means for receiving a selection of one type of motor vehicle from a buyer;
(d) means for displaying a second list of a plurality of options related to the selection;
(e) means for enabling a selection of at least one preferred option from the list of a plurality of options;
(f) means for receiving a selection of at least one preferred option;
(e) means for communicating at least one offer to purchase a motor vehicle of the same type of motor vehicle selected, wherein the motor vehicle offered to purchase includes at least one or more of the selected options and a sales price; and,
(f) means for receiving an acceptance of at least one offer.

12. An apparatus as recited in claim 11, wherein the means for displaying is a personal computer system.

13. An apparatus as recited in claim 11, wherein the means for receiving is a data communication device.

14. An apparatus as recited in claim 11, wherein the means for selecting is a data input device.

15. A system for facilitating a seller-bidding automobile auction, comprising:
a) a memory storage device having a plurality of databases containing automobile data, a multilevel dealer query program, and a multilevel customer query program, wherein the plurality of databases store responses to the customer query program as customer data and automobile configuration data and store responses to the dealer query program as bidding data;
b) at least one customer interface for accessing the multilevel customer query program;
c) at least one automobile dealer interface for accessing the multilevel dealer query program; and,
d) at least one data server in communication with the memory storage device, dealer and customer interfaces, wherein the data server is responsive to the customer and dealer interfaces and adapted to transmit data between the customer and dealer interfaces and memory storage.

16. A system as recited in claim 15, wherein the memory storage device further comprises a database for storing automobile dealer inventory data.

17. A system as recited in claim 15, wherein the automobile data comprises video, text and picture media.

18. A system as recited in claim 15, wherein the data server is in communication with the dealer and customer input/display devices through a distributed computing network.

19. A system as recited in claim 15, wherein the multilevel query program comprises a plurality of web pages.

20. A machine readable media for facilitating a seller-bidding auction, comprising:
a) a data segment for,
i) storing customer data relating to personal information about a customer;
ii) storing automobile data relating to a plurality of automobiles and their associated customizable features;
iii) storing automobile configuration data relating to the customer;
iv) storing dealer data relating to a plurality of automobile dealers selling automobiles; and
b) a code segment for,
i) receiving the customer data;
ii) retrieving the automobile data;
iii) receiving the automobile configuration data;
iv) retrieving the dealer data;
v) evaluating the dealer data based on the automobile configuration data to locate and select dealers included in the dealer data selling automobiles relating to the automobile configuration data;
vi) transmitting the automobile configuration data to the selected dealers;
vii) receiving bid data from the selected dealers; and
viii) transmitting bid data to the customer.
